(19) United States
(12) Patent Application Publication
(10) Pub. No.: US 2019/0217406 A1
(43) Pub. Date: Jul. 18, 2019

(54) GEAR MACHINING APPARATUS AND GEAR MACHINING METHOD

(71) Applicant: JTEKT CORPORATION, Osaka-shi (JP)

(72) Inventors: Lin Zhang, Nagoya-shi (JP); Masaki Ichikawa, Kuwana-shi (JP); Hisashi Otani, Anjo-shi (JP); Hiroyuki Nakano, Tokai-shi (JP)

(73) Assignee: JTEKT CORPORATION, Osaka-shi (JP)

(21) Appl. No.: 16/238,575

(22) Filed: Jan. 3, 2019

(30) Foreign Application Priority Data
Jan. 12, 2018 (JP) 2018-003373

(51) Int. Cl. B23F 1/06

(52) U.S. Cl. CPC B23F 1/06

(57) ABSTRACT

A gear machining method includes a first intersection angle setting step of setting a first intersection angle with a rotation axis of a workpiece during machining of a second tooth flank, a first rotational direction setting step of setting a rotational direction of the workpiece and a rotational direction of a machining tool during machining of the second tooth flank to a same rotational direction, and a second rotational direction setting step of setting a rotational direction of the workpiece and a rotational direction of the machining tool during machining of a fourth tooth flank to a same rotational direction that is opposite to the rotational direction during machining of the second tooth flank.

### INCORPORATION BY REFERENCE

The disclosure of Japanese Patent Application No. 2018-003373 filed on Jan. 12, 2018, including the specification, drawings and abstract, is incorporated herein by reference in its entirety.

### BACKGROUND OF THE INVENTION

### 1. Field of the Invention

The present invention relates to a gear machining apparatus and a gear machining method for machining a gear.

### 2. Description of the Related Art

Transmissions used in vehicles are provided with a synchromesh mechanism for smooth gear shifting. As illustrated in FIG. 22, a key-type synchromesh mechanism 110 includes a main shaft 111, a main drive shaft 112, a clutch hub 113, keys 114, a sleeve 115, a main drive gear 116, a clutch gear 117, and a synchronizer ring 118.

The main shaft 111 and the main drive shaft 112 are coaxially arranged. The clutch hub 113 is spline-fitted to the main shaft 111, so that the main shaft 111 and the clutch hub 113 rotate together. The keys 114 are supported at three points on the outer periphery of the clutch hub 113 with a spring (not illustrated). The sleeve 115 has inner teeth (splines) 115a on the inner periphery thereof, and the sleeve 115 slides in a direction of a rotation axis LL along the splines (not illustrated) formed on the outer periphery of the clutch hub 113, together with the keys 114.

The main drive gear 116 is fitted on the main drive shaft 112, and the clutch gear 117 having a tapered cone 117b projecting therefrom is formed integrally on the sleeve 115 side of the main drive gear 116. The synchronizer ring 118 is disposed between the sleeve 115 and the clutch gear 117. Outer teeth 117a of the clutch gear 117 and outer teeth 118a of the synchronizer ring 118 are formed to mesh with the inner teeth 115a of the sleeve 115. The inner periphery of the synchronizer ring 118 is formed in a tapered shape to frictionally engage the outer periphery of the tapered cone 117b.

In the following, the operation of the synchromesh mechanism 110 will be described. As illustrated in FIG. 23A, the sleeve 115 and the keys 114 move in the direction of the rotation axis LL indicated by the arrow in FIG. 23A when the shift lever (not illustrated) is operated. The keys 114 push the synchronizer ring 118 in the direction of the rotation axis LL to press the inner periphery of the synchronizer ring 118 against the outer periphery of the tapered cone 117b. Thus, the clutch gear 117, the synchronizer ring 118, and the sleeve 115 start rotating synchronously.

Then, as illustrated in FIG. 23B, the keys 114 are pushed down by the sleeve 115 to further press the synchronizer ring 118 in the direction of the rotation axis LL, so that the inner periphery of the synchronizer ring 118 and the outer periphery of the tapered cone 117b contact more tightly. This generates a large frictional force, so that the clutch gear 117, the synchronizer ring 118, and the sleeve 115 rotate synchronously. When the rotational speed of the clutch gear 117 and the rotational speed of the sleeve 115 synchronize completely, the frictional force between the inner periphery of the synchronizer ring 118 and the outer periphery of the tapered cone 117b is lost.

When the sleeve 115 and the keys 114 move further in the direction of the rotation axis LL indicated by the arrow in FIG. 23B, the keys 114 fit into grooves 118b of the synchronizer ring 118 and stop. However, the sleeve 115 moves beyond projecting portions 114a of the keys 114, and the inner teeth 115a of the sleeve 115 mesh with the outer teeth 118a of the synchronizer ring 118. Then, as illustrated in FIG. 23C, the sleeve 115 further moves in the direction of the rotation axis LL, so that the inner teeth 115a of the sleeve 115 mesh with the outer teeth 117a of the clutch gear 117. In this way, shifting is completed.

In the synchromesh mechanism 110 described above, in order to prevent disengagement between the outer teeth 117a of the clutch gear 117 and the inner teeth 115a of the sleeve 115 during travel, a tapered gear disengagement preventing portion 120 is provided on each inner tooth 115a of the sleeve 115, and a tapered gear disengagement preventing portion 117c that taper-fits to the gear disengagement preventing portion 120 is provided on each outer tooth 117a of the clutch gear 117, as illustrated in FIGS. 24A and 24B. In the following description, a side surface 115A on the left side (FIG. 24A) of the inner tooth 115a of the sleeve 115 is referred to as a “left side surface 115A” (corresponding to “one side surface” according to the present invention) and a side surface 115B on the right side (FIG. 24A) of the inner tooth 115a of the sleeve 115 is referred to as a “right side surface 115B” (corresponding to “another side surface” according to the present invention).

The left side surface 115A of the inner tooth 115a of the sleeve 115 includes a left flank 115b (corresponding to a “first tooth flank” according to the present invention) and a tooth flank 121 having a different helix angle from the left flank 115b (hereinafter referred to as a “left tapered flank 121”, and corresponding to a “second tooth flank” according to the present invention). The right side surface 115B of the inner tooth 115a of the sleeve 115 includes a right flank 115c (corresponding to a “third tooth flank” according to the present invention) and a tooth flank 122 having a different helix angle from the right flank 115c (hereinafter referred to as a “right tapered flank 122”, and corresponding to a “fourth tooth flank” according to the present invention).

In this example, the helix angle of the left flank 115b is 0 degree; the helix angle of the left tapered flank 121 is θf degrees; the helix angle of the right flank 115c is 0 degree; and the helix angle of the right tapered flank 122 is θg degrees. The left tapered flank 121, a tooth flank 121a connecting the left tapered flank 121 and the left flank 115b (hereinafter referred to as a “left sub flank 121a”), the right tapered flank 122, and a tooth flank 122a connecting the right tapered flank 122 and the right flank 115c (hereinafter referred to as a “right sub flank 122a”) form the gear disengagement preventing portion 120. Gear disengagement is prevented by taper-fitting the left tapered flank 121 and the gear disengagement preventing portion 117c to each other.

As described above, the structure of the inner teeth 115a of the sleeve 115 is complicated. Moreover, the sleeve 115 is a mass-produced component. Therefore, the inner teeth 115a of the sleeve 115 (corresponding to a workpiece according to the present invention) are generally formed by broaching, gear shaping, or the like, and the gear disengagement preventing portions 120 are formed by rolling (see Japanese Utility Model Application Publication No. 06-061340 (JP 06-061340 U) and Japanese Patent Application Publication No. 2005-152940 (JP 2005-152940 A)).

In order to reliably prevent the gear disengagement described above in the synchromesh mechanism 110, the gear disengagement preventing portions 120 of the inner teeth 115a of the sleeve 115 need to be accurately machined. However, since the gear disengagement preventing portions 120 are formed by rolling, which is plastic processing, the processing accuracy tends to be low. In order to achieve higher accuracy, the gear disengagement preventing portions 120 may be formed by cutting (skiving).

However, in the case of machining the left tapered flank 121 and the right tapered flank 122 by skiving, since the rotational direction of the sleeve 115 and the rotational direction of the machining tool are the same, the tool locus during machining of the left tapered flank 121 and the tool locus during machining of the right tapered flank 122 are different, and hence the shape of left tapered flank 121 and the shape of the right tapered flank 122 are asymmetrical to each other. A specific example of the shapes that are asymmetrical to each other will be described in detail below.

### SUMMARY OF THE INVENTION

An object of the present invention is to provide a gear machining apparatus and a gear machining method capable of machining a tooth flank having a different helix angle on each of the right and left side surfaces of each tooth such that the tooth has a symmetrical shape.

According to an aspect of the present invention, a gear machining apparatus includes a control device that controls machining of a gear by relatively moving a machining tool in a rotation axis direction of a workpiece while rotating the machining tool in synchronization with the workpiece, and the machining tool includes a plurality of cutting teeth on an outer periphery of the machining tool. One side surface of each of teeth of the gear includes a first tooth flank, and a second tooth flank having a different helix angle from the first tooth flank; and another side surface of each of the teeth of the gear includes a third tooth flank, and a fourth tooth flank having a different helix angle from the third tooth flank.

The control device is configured to set a first intersection angle between a rotation axis of the workpiece and a rotation axis of the machining tool during machining of the second tooth flank, set a rotational direction of the workpiece and a rotational direction of the machining tool during machining of the second tooth flank to a same rotational direction, and set a rotational direction of the workpiece and a rotational direction of the machining tool during machining of the fourth tooth flank to a same rotational direction that is opposite to the rotational direction during machining of the second tooth flank.

According to another aspect of the present invention, a gear machining method is a method of machining the gear using the machining tool. The gear machining method includes: a first intersection angle setting step of setting a first intersection angle between a rotation axis of the workpiece and a rotation axis of the machining tool during machining of the second tooth flank; a first rotational direction setting step of setting a rotational direction of the workpiece and a rotational direction of the machining tool during machining of the second tooth flank to a same rotational direction; and a second rotational direction setting step of setting a rotational direction of the workpiece and a rotational direction of the machining tool during machining of the fourth tooth flank to a same rotational direction that is opposite to the rotational direction during machining of the second tooth flank.

According to the gear machining apparatus and the gear machining method of the aspects described above, the rotational direction of the machining tool and the rotational direction of the workpiece during machining of the second tooth flank are set to the same rotational direction, and the rotational direction of the machining tool and the rotational direction of the workpiece during machining of the fourth tooth flank are set to the same rotational direction that is opposite to the rotational direction during machining of the second tooth flank. Accordingly, the tool locus during machining of the second tapered flank and the tool locus during machining of the fourth tapered flank are the same, and the shape of the second tooth flank of the gear and the shape of the fourth tooth flank of the gear can be made symmetrical to each other. Therefore, the machining accuracy of the gear can be improved.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 illustrates the overall configuration of a gear machining apparatus according to an embodiment of the present invention;

FIG. 2 is a flowchart illustrating a tool designing process for a tapered flank machining tool, performed by the control device of FIG. 1;

FIG. 3 is a flowchart illustrating a tool condition setting process for a tapered flank machining tool, performed by the control device of FIG. 1;

FIG. 4 is a flowchart illustrating a process of controlling machining with the tapered flank machining tool, performed by the control device of FIG. 1;

FIG. 5A illustrates the schematic configuration of a left tapered flank machining tool as viewed in a rotation axis direction from a tool end face side;

FIG. 5B is a partial cross-sectional view illustrating the schematic configuration of the machining tool of FIG. 5A as viewed in a radial direction;

FIG. 5C is an enlarged view illustrating a cutting tooth of the machining tool of FIG. 5B;

FIG. 6A illustrates the dimensional relationship between the machining tool and a sleeve when designing the left tapered flank machining tool, as viewed in a radial direction of the sleeve;

FIG. 6B illustrates the positional relationship between the cutting tooth of the machining tool and an inner tooth of the sleeve when designing the left tapered flank machining tool, as viewed in the radial direction of the sleeve;

FIG. 7 illustrates elements of the machining tool used when calculating a top land thickness and a tooth thickness of the tapered flank machining tool;

FIG. 8 is a detailed view illustrating the shape of an inner tooth of a sleeve when the present invention is not applied, as viewed in the radial direction;

FIG. 9A illustrates how a left tapered flank of the inner tooth of FIG. 8 is machined with the machining tool, as viewed in a rotation axis direction of the sleeve;

FIG. 9B illustrates how a right tapered flank of the inner tooth of FIG. 8 is machined with the machining tool, as viewed in the rotation axis direction of the sleeve;

FIG. 10A illustrates how a left tapered flank of an inner tooth is machined with the machining tool when the present invention is applied, as viewed in a rotation axis direction of the sleeve;

FIG. 10B illustrates how a right tapered flank of the inner tooth is machined with the machining tool when the present invention is applied, as viewed in the rotation axis direction of the sleeve;

FIG. 11 is a detailed view illustrating the shape of an inner tooth of a sleeve when the present invention is applied, as viewed in the radial direction;

FIG. 12A illustrates the dimensional relationship between the machining tool and a sleeve when designing the right tapered flank machining tool, as viewed in the radial direction of the sleeve;

FIG. 12B illustrates the positional relationship between the cutting tooth of the machining tool and an inner tooth of the sleeve when designing the right tapered flank machining tool, as viewed in the radial direction of the sleeve;

FIG. 13A illustrates the state of the cutting tooth of the left tapered flank machining tool as viewed in the radial direction;

FIG. 13B illustrates the state of the cutting tooth of the right tapered flank machining tool as viewed in the radial direction;

FIG. 14A illustrates the positional relationship between the machining tool and the sleeve when changing the tool position of the tapered flank machining tool in the rotation axis direction;

FIG. 14B is a first diagram illustrating a machined state when the axial position is changed;

FIG. 14C is a second diagram illustrating a machined state when the axial position is changed;

FIG. 14D is a third diagram illustrating a machined state when the axial position is changed;

FIG. 15A illustrates the positional relationship between the machining tool and the sleeve when changing an intersection angle representing the inclination of the rotation axis of the tapered flank machining tool with respect to the rotation axis of the sleeve;

FIG. 15B is a first diagram illustrating a machined state when the intersection angle is changed;

FIG. 15C is a second diagram illustrating a machined state when the intersection angle is changed;

FIG. 15D is a third diagram illustrating a machined state when the intersection angle is changed;

FIG. 16A illustrates the positional relationship between the machining tool and the sleeve when changing the position of the tapered flank machining tool in the rotation axis direction and the intersection angle;

FIG. 16B is a first diagram illustrating a machined state when the axial position and the intersection angle are changed;

FIG. 16C is a second diagram illustrating a machined state when the axial position and the intersection angle are changed;

FIG. 17A illustrates the position of the machining tool before the left tapered flank is machined, as viewed in the radial direction;

FIG. 17B illustrates the position of the machining tool when the left tapered flank is being machined as viewed in the radial direction;

FIG. 17C illustrates the position of the machining tool after the left tapered flank is machined, as viewed in the radial direction;

FIG. 18 is a flowchart illustrating a tool designing process for another tapered flank machining tool, performed by the control device of FIG. 1;

FIG. 19A illustrates the schematic configuration of a machining tool for a left tapered flank and a right tapered flank as viewed in the rotation axis direction from a tool end face side;

FIG. 19B is a partial cross-sectional view illustrating the schematic configuration of the machining tool of FIG. 19A as viewed in a radial direction;

FIG. 19C is an enlarged view illustrating a cutting tooth of the machining tool of FIG. 19B;

FIG. 20 illustrates the machining conditions for machining a left tapered flank and a right tapered flank with another tapered flank machining tool, with different intersection angles;

FIG. 21 illustrates the machining conditions for machining a left tapered flank and a right tapered flank with another tapered flank machining tool, with the same intersection angle and different machining positions;

FIG. 22 is a cross-sectional view illustrating a synchromesh mechanism having the sleeve as a workpiece;

FIG. 23A is a cross-sectional view illustrating a state of the synchromesh mechanism of FIG. 22 before starting operation;

FIG. 23B is a cross-sectional view illustrating a state of the synchromesh mechanism of FIG. 22 during operation;

FIG. 23C is a cross-sectional view illustrating a state of the synchromesh mechanism of FIG. 22 after completion of operation;

FIG. 24A is a perspective view illustrating a gear disengagement preventing portion of the sleeve; and

FIG. 24B illustrates the gear disengagement preventing portion of the sleeve of FIG. 24A as viewed in the radial direction.

### DETAILED DESCRIPTION OF EMBODIMENTS

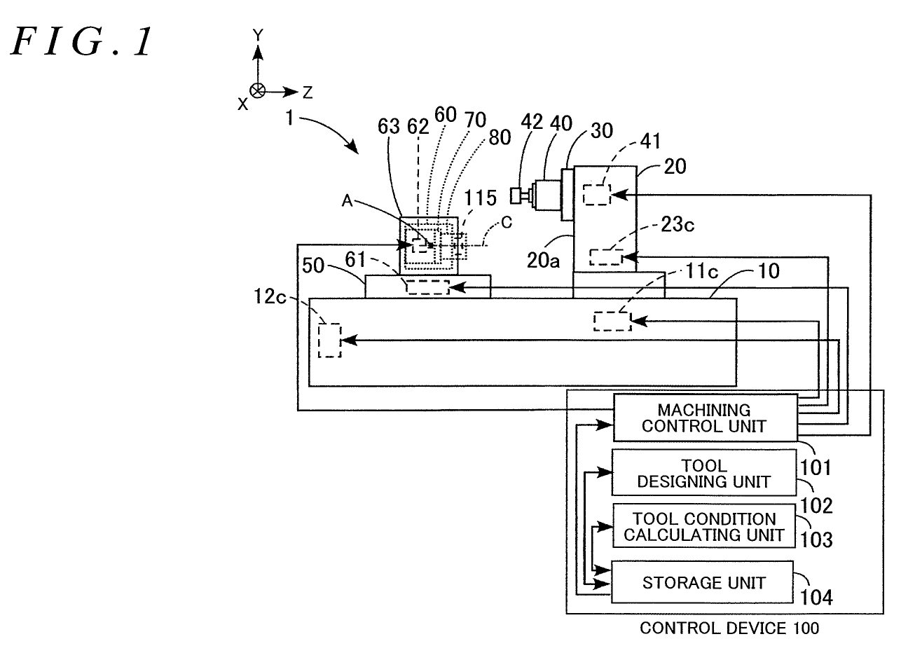

In the present embodiment, a five-axis machining center will be described as an example of a gear machining apparatus, with reference to FIG. 1. That is, the gear machining apparatus 1 is an apparatus having three rectilinear axes (X-, Y-, and Z-axes) orthogonal to each other as drive axes, and two rotation axes (an A-axis parallel to the X-axis, and a C-axis perpendicular to the A-axis).

As described in BACKGROUND OF THE INVENTION, the gear disengagement preventing portions 120 are formed by rolling, which is plastic processing, on the inner teeth 115a of the sleeve 115 formed by broaching or gear shaping. Therefore, the processing accuracy tends to be low. To deal with this issue, the above-described gear machining apparatus 1 first forms the inner teeth 115a of the sleeve 115 by broaching, gear shaping, or the like, and then forms the gear disengagement preventing portions 120 on the inner teeth 115a of the sleeve 115 by cutting with a machining tool 42 (described below).

Specifically, the rotation axis of the sleeve 115 having the inner teeth 115a formed thereon and the rotation axis of the machining tool 42 are inclined at a predetermined intersection angle, and then the gear disengagement preventing portions 120 are formed by rotating the sleeve 115 and the machining tool 42 synchronously and cutting the sleeve 115 while the machining tool 42 is fed in the rotation axis direction of the sleeve 115. Thus, the gear disengagement preventing portions 120 are accurately machined.

As illustrated in FIG. 1, the gear machining apparatus 1 includes a bed 10, a column 20, a saddle 30, a rotary spindle 40, a table 50, a tilt table 60, a turntable 70, a workpiece holder 80, and a control device 100. Although not illustrated, a known automatic tool replacement device is provided next to the bed 10.

The bed 10 is substantially rectangular, and is disposed on the floor. An X-axis ball screw (not illustrated) for driving the column 20 in a direction parallel to the X-axis is disposed on the upper surface of the bed 10. Further, an X-axis motor 11c that rotates the X-axis ball screw is mounted on the bed 10.

A Y-axis ball screw (not illustrated) for driving the saddle 30 in a direction parallel to the Y-axis is disposed on a side surface (sliding surface) 20a of the column 20 parallel to the Y-axis. Further, a Y-axis motor 23c that rotates the Y-axis ball screw is mounted on the column 20.

The rotary spindle 40 supports the machining tool 42, is rotatably supported on the saddle 30, and is rotated by a spindle motor 41 accommodated in the saddle 30. The machining tool 42 is held on a tool holder (not illustrated) and fixed to the distal end of the rotary spindle 40, and rotates with the rotation of the rotary spindle 40. The machining tool 42 moves with respect to the bed 10 in the direction parallel to the X-axis and the direction parallel to the Y-axis with the movement of the column 20 and the saddle 30. The machining tool 42 will be described in detail below.

A Z-axis ball screw (not illustrated) for driving the table 50 in a direction parallel to the Z-axis is disposed on the upper surface of the bed 10. Further, a Z-axis motor 12c that rotates the Z-axis ball screw is mounted on the bed 10.

Tilt table support portions 63 that support the tilt table 60 are provided on the upper surface of the table 50. The tilt table 60 is disposed on the tilt table support portions 63 so as to be rotatable (turnable) about an axis parallel to the A-axis. The tilt table 60 is rotated (turned) by an A-axis motor 61 accommodated in the table 50.

The turntable 70 is disposed on the tilt table 60 so as to be rotatable about an axis parallel to the C-axis. The workpiece holder 80 that holds the sleeve 115 as a workpiece is mounted on the turntable 70. The turntable 70 is rotated by a C-axis motor 62 together with the sleeve 115 and the workpiece holder 80.

The control device 100 includes a machining control unit 101, a tool designing unit 102, a tool condition calculating unit 103, and a storage unit 104. Here, each of the machining control unit 101, the tool designing unit 102, the tool condition calculating unit 103, and the storage unit 104 may be implemented by hardware or software.

The machining control unit 101 cuts the sleeve 115 by controlling the spindle motor 41 to rotate the machining tool 42, controlling the X-axis motor 11c, the Z-axis motor 12c, and the Y-axis motor 23c to move the sleeve 115 and the machining tool 42 relative to each other in the direction parallel to the X-axis direction, the direction parallel to the Z-axis direction, and the direction parallel to the Y-axis direction, respectively, and controlling the A-axis motor 61 and the C-axis motor 62 to rotate the sleeve 115 and the machining tool 42 about the axis parallel to the A-axis and the axis parallel to the C-axis, respectively.

The tool designing unit 102 calculates the parameters of the machining tool 42 to design the machining tool 42, as will be described in detail below.

The tool condition calculating unit 103 calculates tool conditions indicating the relative position and posture of the machining tool 42 with respect to the sleeve 115, as will be described in detail below.

The storage unit 104 stores in advance tool data related to the machining tool 42, that is, a tip diameter da, a reference diameter d, an addendum ha, a module m, a profile shift coefficient λ, a pressure angle α, a transverse pressure angle αt, a tip pressure angle αa, and machining data for cutting the sleeve 115. The storage unit 104 also stores the number of cutting teeth 42a Z and so on that are input when the machining tool 42 is designed, shape data of the machining tool 42 designed by the tool designing unit 102, and the tool condition calculated by the tool condition calculating unit 103.

In this example, the left tapered flank 121 including the left sub flank 121a and the right tapered flank 122 including the right sub flank 122a of each gear disengagement preventing portion 120 of the sleeve 115 are formed by cutting with two respective machining tools 42.

The following describes how to design the machining tool 42 for cutting the left tapered flank 121 (hereinafter referred to as a “first machining tool 42F”). The same applies to designing of the machining tool 42 for cutting the right tapered flank 122 (hereinafter referred to as a “second machining tool 42G”), and therefore a detailed description thereof will not be given.

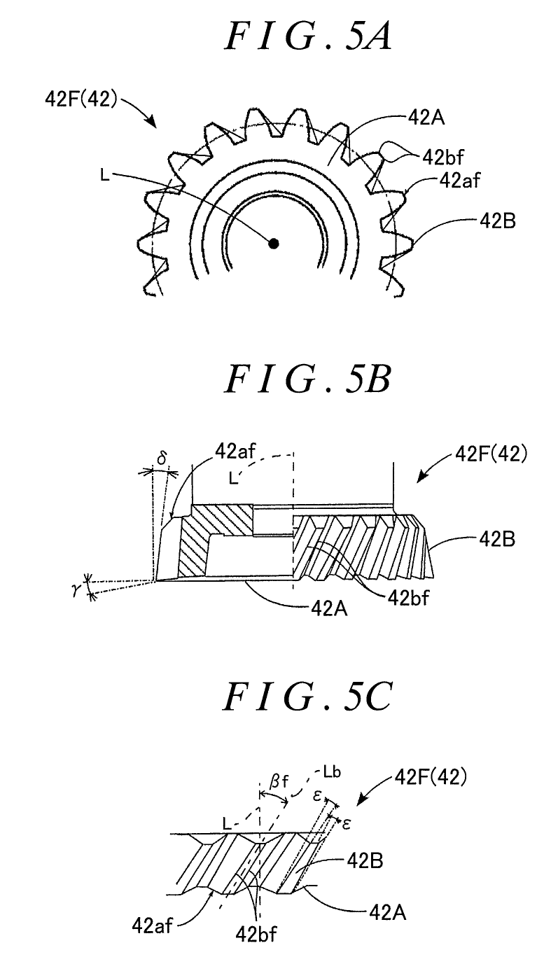

As illustrated in FIG. 5A, in this example, a cutting tooth 42af when the first machining tool 42F is viewed in the direction of a tool axis (rotation axis) L from a tool end face 42A side is formed in the same shape as an involute curve shape. Further, as illustrated in FIG. 5B, the cutting tooth 42af of the first machining tool 42F has a rake angle inclined at an angle γ with respect to a plane perpendicular to the tool axis L on the tool end face 42A side, and a front relief angle inclined at an angle δ with respect to a line parallel to the tool axis L on a tool peripheral surface 42B side.

As illustrated in FIG. 5C, the cutting tooth 42af of the first machining tool 42F has a side relief angle inclined at an angle ε such that the circumferential width (the distance between two tooth traces 42bf) on the tool peripheral surface 42B side gradually decreases from the tool end face 42A side in the tooth trace direction. Further, the cutting tooth 42af has a helix angle inclined by an angle βf with respect to the tool axis L when a line Lb at the center between the two tooth traces 42bf is viewed in the radial direction.

As described above, the left tapered flank 121 of the sleeve 115 is formed by cutting the previously formed inner tooth 115a of the sleeve 115 with the first machining tool 42F. Therefore, the cutting tooth 42af of the first machining tool 42F needs to have a shape such that, while cutting the inner tooth 115a, the left tapered flank 121 including the left sub flank 121a can be reliably cut, without interference with the adjacent inner tooth 115a.

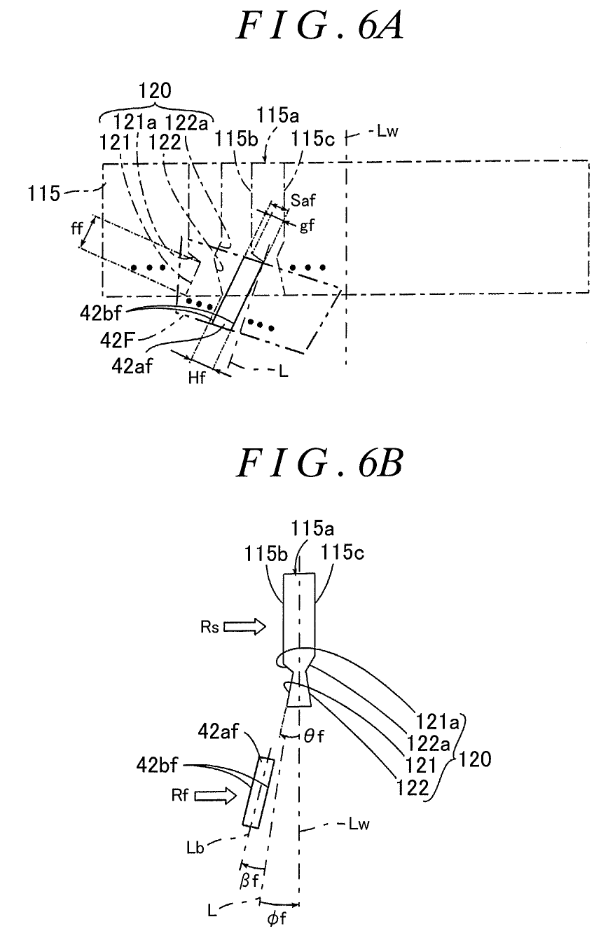

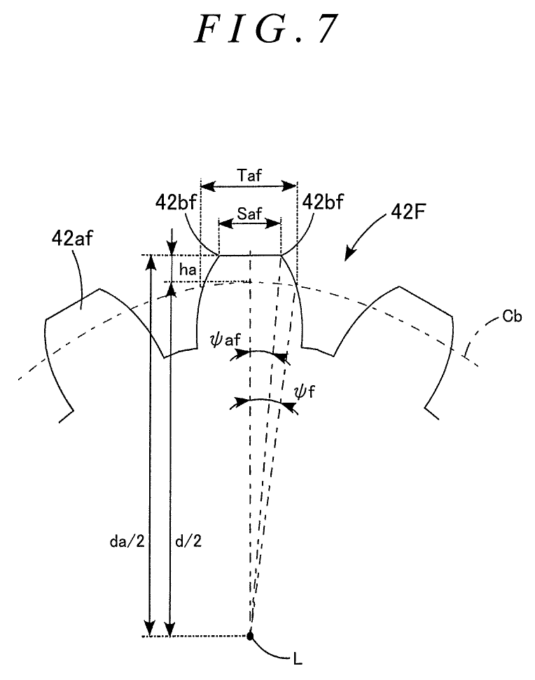

Specifically, as illustrated in FIG. 6A, the cutting tooth 42af needs to be designed such that: a top land thickness Saf of the cutting tooth 42af is greater than a tooth trace length gf of the left sub flank 121a; and a tooth thickness Taf of the cutting tooth 42af at a reference circle Cb (see FIG. 7) is less than a distance Hf (hereinafter referred to as a “tooth flank interval Hf”) between the left tapered flank 121 and an open end of the right tapered flank 122 facing the left tapered flank 121, when the cutting tooth 42af cuts the left tapered flank 121 by a tooth trace length ff.

The top land thickness Saf of the cutting tooth 42af and the tooth thickness Taf of the cutting tooth 42af at the reference circle Cb are set taking into account the durability of the cutting tooth 42af such as chipping resistance. When the cutting tooth 42af is designed, as illustrated in FIG. 6B, an intersection angle φf between a rotation axis Lw of the sleeve 115 and the rotation axis L of the machining tool 42 (the intersection angle φf given by the sum of a helix angle θf of the left tapered flank 121 and the helix angle βf of the cutting tooth 42af (hereinafter referred to as an “intersection angle φf of the first machining tool 42F”) needs to be set first.

In FIG. 6B, the rotation axis Lw of the sleeve 115 is located at the center of the inner tooth 115a (the center between the left tapered flank 121 and the right tapered flank 122). The rotation axis L of the machining tool 42 is located on the left tapered flank 121 side of the rotation axis Lw of the sleeve 115. Further, the intersection angle φf is positive in the direction from the rotation axis L of the machining tool 42 to the rotation axis Lw of the sleeve 115 (counterclockwise direction) in FIG. 6B.

The helix angle θf of the left tapered flank 121 is negative in the direction from the rotation axis Lw of the sleeve 115 to the left tapered flank 121 (clockwise direction) in FIG. 6B. The helix angle βf of the cutting tooth 42af is negative in the direction from the rotation axis L of the machining tool 42 to the tooth trace 42bf (in this example, the line Lb at the center between the two tooth traces 42bf) (clockwise direction) in FIG. 6B.

Further, in this example, a rotational direction Rs of the sleeve 115 as viewed from the end face side on which the left tapered flank 121 is formed is counterclockwise, and a rotational direction Rf of the first machining tool 42F as viewed from the side opposite to the tool end face 42A is also counterclockwise. In this case, the intersection angle φf of the first machining tool 42F is set to a positive angle. The operator tentatively sets the intersection angle φf of the first machining tool 42F for which a possible setting range is specified by the gear machining apparatus 1 to any positive angle.

Subsequently, the helix angle βf of the cutting tooth 42af is calculated from the known helix angle θf of the left tapered flank 121 and the set intersection angle φf of the first machining tool 42F, and the top land thickness Saf of the cutting tooth 42af and the tooth thickness Taf of the cutting tooth 42af at the reference circle Cb are calculated. By repeating the process described above, the first machining tool 42F having the optimal cutting teeth 42af for cutting the left tapered flanks 121 is designed.

An example of calculating the top land thickness Saf of the cutting tooth 42af and the tooth thickness Taf of the cutting tooth 42af at the reference circle Cb will be described below. As illustrated in FIG. 7, the top land thickness Saf of the cutting tooth 42af is represented by the tip diameter da and a tip tooth thickness half angle Iv af (see expression (1)).

Saf=ψaf·da (1)

The tip diameter da is represented by the reference diameter d and the addendum ha (see expression (2)); the reference diameter d is represented by the number of cutting teeth 42af Z, the helix angle βf of the tooth trace 42bf of the cutting tooth 42af, and the module m (see expression (3)); and the addendum ha is represented by the profile shift coefficient λ and the module m (see expression (4)).

da=d+2·ha (2)

d=Z·m/cos βf (3)

ha=2·m(1+λ) (4)

The tip tooth thickness half angle ψaf is represented by the number of cutting teeth 42af Z, the profile shift coefficient λ, the pressure angle α, the transverse pressure angle αt, and the tip pressure angle αa (see expression (5)). The transverse pressure angle αt is represented by the pressure angle α and the helix angle βf of the tooth trace 42bf of the cutting tooth 42af (see expression (6)), and the tip pressure angle αa is represented by the transverse pressure angle αt, the tip diameter da, and the reference diameter d (see expression (7)).

ψaf=π/(2·Z)+2·λ·tan α/Z+(tan αt−αt)−(tan αa−αa) (5)

αt=tan⁻¹(tan α/cos βf) (6)

αa=cos⁻¹(d·cos αt/da) (7)

The tooth thickness Taf of the cutting tooth 42af is represented by the reference diameter d and a half angle ψf of the tooth thickness Taf (see expression (8)).

Taf=ψf·d (8)

The reference diameter d is represented by the number of cutting teeth 42af Z, the helix angle βf of the tooth trace 42bf of the cutting tooth 42af, and the module m (see expression (9)).

d=Z·m/cos βf (9)

The half angle ψf of the tooth thickness Taf is represented by the number of cutting teeth 42af Z, the profile shift coefficient λ, and the pressure angle α (see expression (10)).

ψf=π/(2·Z)+2·λ·tan α/Z (10)

With these calculations, the first machining tool 42F is designed. Similarly, the second machining tool 42G is designed such that the rotational direction Rs of the sleeve 115 as viewed from the end face side on which the right tapered flank 122 is formed is counterclockwise, and a rotational direction Rg of the second machining tool 42G as viewed from the side opposite to the tool end face 42A is also counterclockwise. The parameters of the second machining tool 42G can be obtained by replacing the suffix “f” of the parameters of the first machining tool 42F with “g”.

As mentioned in Description of the Related Art, in the case of machining the left tapered flank 121 and the right tapered flank 122 by skiving, since the rotational direction Rs of the sleeve 115 and the rotational directions Rf and Rg of the first and second machining tools 42F and 42G are the same, the tool locus of the first machining tool 42F during machining of the left tapered flank 121 and the tool locus of the second machining tool 42G during machining of the right tapered flank 122 are different, and hence the shape of left tapered flank 121 and the shape of the right tapered flank 122 are asymmetrical to each other.

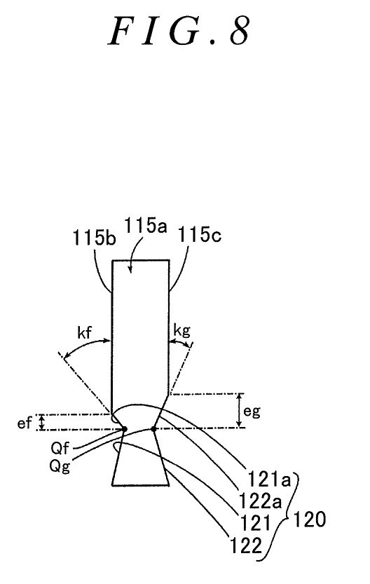

Specifically, after the left tapered flank 121 and the right tapered flank 122 are machined with the first machining tool 42F and the second machining tool 42G, respectively, the left sub flank 121a and the right sub flank 122a are formed with the first machining tool 42F and the second machining tool 42G moving away from the left tapered flank 121 and the right tapered flank 122, respectively. However, as illustrated in FIG. 8, a release length eg of the right sub flank 122a is less than a release length ef of the left sub flank 121a, and a release angle kg of the right sub flank 122a is less than a release angle kf of the left sub flank 121a.

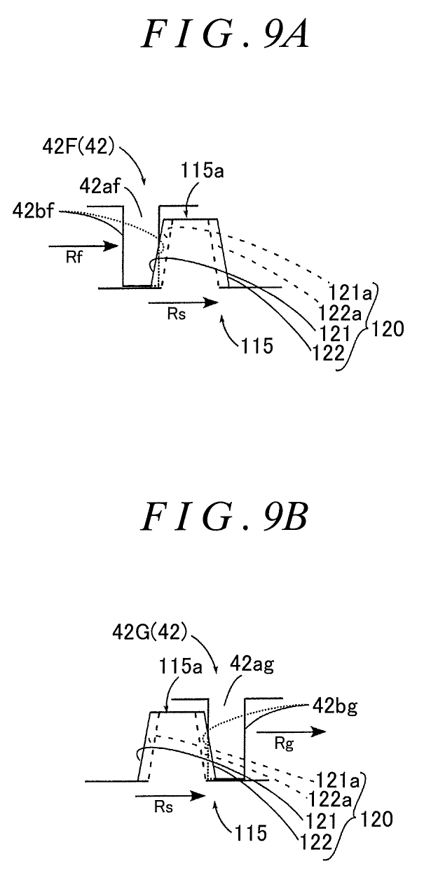

This is because, as illustrated in FIG. 9A, the cutting tooth 42af of the first machining tool 42F rotating in the counterclockwise rotational direction Rf moves from a cutting end position Qf (see FIG. 8) of the left tapered flank 121 of the sleeve 115 rotating in the counterclockwise rotational direction Rs to the radially inner side of the sleeve 115.

In this case, since the first machining tool 42F has a smaller diameter than the sleeve 115, and since the cutting tooth 42af follows the left tapered flank 121, it takes relatively short time for the cutting tooth 42af to separate from the left tapered flank 121. Accordingly, it is estimated that the release length ef of the left sub flank 121a is relatively short, and that the release angle kf is relatively large.

On the other hand, as illustrated in FIG. 9B, a cutting tooth 42ag of the second machining tool 42G rotating in the counterclockwise rotational direction Rg moves from a cutting end position Qg (see FIG. 8) of the right tapered flank 122 of the sleeve 115 rotating in the counterclockwise rotational direction Rs to the radially inner side of the sleeve 115.

In this case, since the second machining tool 42G has a smaller diameter than the sleeve 115, and since the right tapered flank 122 follows the cutting tooth 42ag, it takes relatively long time for the cutting tooth 42ag to separate from the right tapered flank 122. Accordingly, it is estimated that the release length eg of the right sub flank 122a is relatively long, and that the release angle kg is relatively small.

In the case where the release length eg of the right sub flank 122a is greater than the release length ef of the left sub flank 121a as described above, it takes time to prevent the sleeve 115 from sliding when the inner teeth 115a of the sleeve 115 mesh with the outer teeth 118a of the synchronizer ring 118 (when shifting gears). In addition, the strength of the inner teeth 115a is reduced. Further, when the shape of the left sub flank 121a and the shape of the right sub flank 122a are asymmetrical to each other, synchronization time differs between the left sub flank 121a and the right sub flank 122a, so that the meshing position is unstable. Moreover, the meshing position is different during acceleration of the vehicle and during deceleration of the vehicle, so that it is difficult to achieve stable acceleration and deceleration.

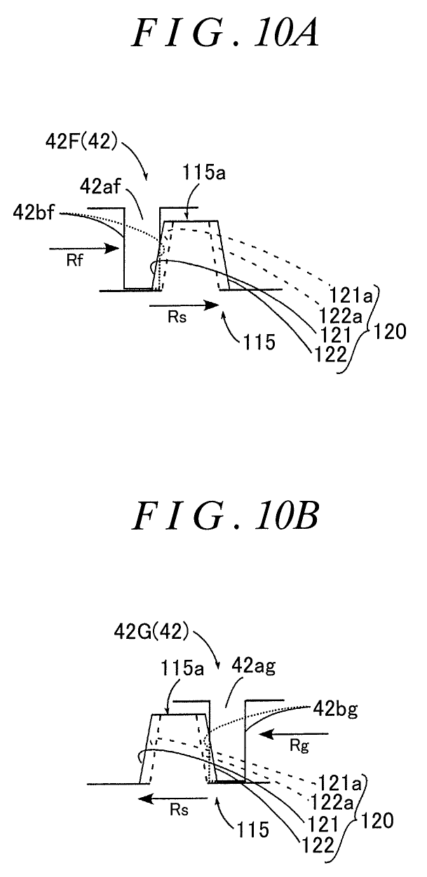

In view of the above, as illustrated in FIG. 10A, when the cutting tooth 42af of the first machining tool 42F machines the left tapered flank 121 of the sleeve 115, the first machining tool 42F is rotated in the counterclockwise rotational direction Rf, and the sleeve 115 is also rotated in the counterclockwise rotational direction Rs.

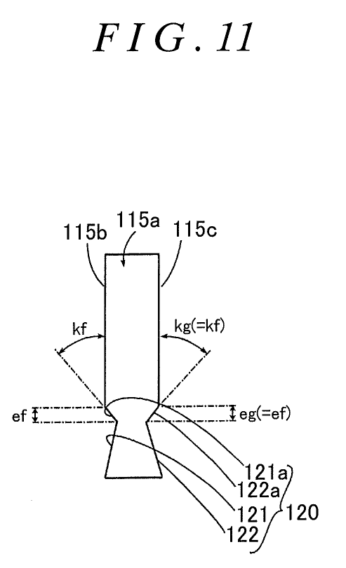

Meanwhile, as illustrated in FIG. 10B, when the cutting tooth 42ag of the second machining tool 42G machines the right tapered flank 122 of the sleeve 115, the second machining tool 42G is rotated in the clockwise rotational direction Rg (a rotational direction opposite to the rotational direction of the first machining tool 42F), and the sleeve 115 is also rotated in the clockwise rotational direction Rs (a rotational direction opposite to the rotational direction of the sleeve 115 in FIG. 10A). Thus, as illustrated in FIG. 11, the release length eg of the right sub flank 122a is reduced to be the same as the release length ef of the left sub flank 121a, so that the shape of the left sub flank 121a and the shape of the right sub flank 122a can be made symmetrical to each other.

When the shape of the left tapered flank 121 and the shape of the right tapered flank 122 are asymmetrical to each other, as illustrated in FIGS. 6A and 6B, both the intersection angle φf of the first machining tool 42F and the intersection angle φg of the second machining tool 42G are set to positive angles in the case of performing machining while all the rotational directions of Rf, Rg, and Rs of the first machining tool 42F, the second machining tool 42G; and the sleeve 115 during machining are set to be counterclockwise.

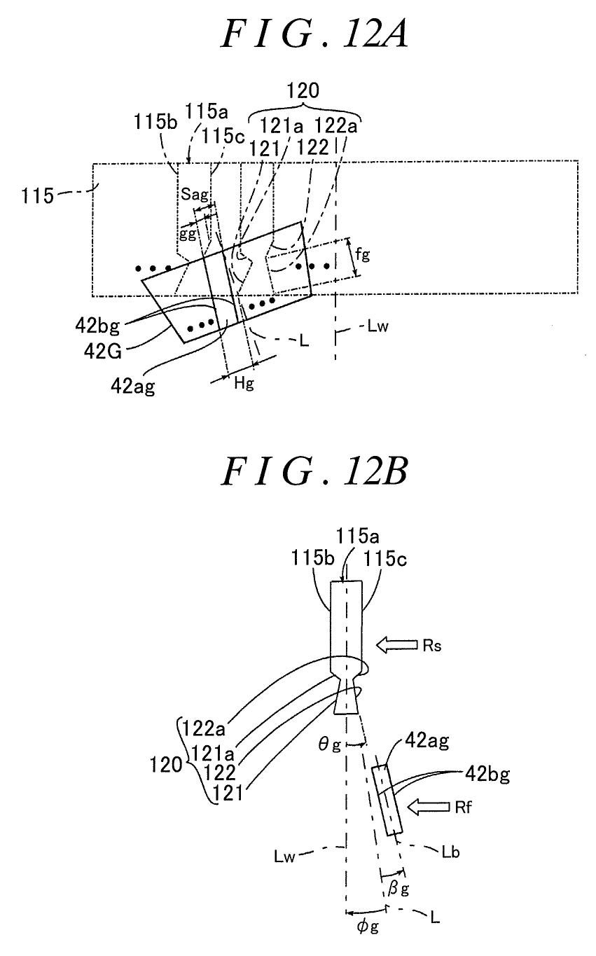

However, to make the shape of the left sub flank 121a and the shape of the right sub flank 122a symmetrical to each other, as illustrated in FIGS. 12A and 12B, the intersection angle φf (see FIG. 6B) of the first machining tool 42F needs to be a positive angle, and the intersection angle φg of the second machining tool 42G needs to be a negative angle in the case of performing machining while the rotational directions of Rf and Rs of the first machining tool 42F and sleeve 115 during machining are set to be counterclockwise and the rotational directions Rg and Rs of the second machining tool 42G and the sleeve 115 during machining are set to be clockwise. That is, the intersection directions need to be opposite. Further, the intersection angle φf of the first machining tool 42F and the intersection angle φg of the second machining tool 42G need to have the same absolute value. Note that the first machining tool 42F is the same as that described above.

Subsequently, by using the above expressions (1) to (10), the helix angle βg of the cutting tooth 42ag is calculated from the known helix angle θg of the right tapered flank 122 and the set intersection angle φg of the second machining tool 42G; and the top land thickness Sag of the cutting tooth 42ag and the tooth thickness Tag of the cutting tooth 42ag at the reference circle Cb are calculated. By repeating the process described above, the second machining tool 42G having the optimal cutting teeth 42ag for cutting the right tapered flanks 122 is designed.

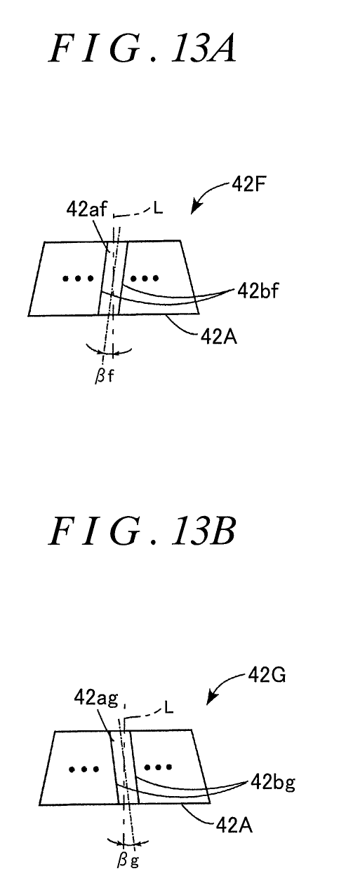

In the manner described above, as illustrated in FIG. 13A, the first machining tool 42F is designed such that the tooth trace 42bf of the cutting tooth 42af has the helix angle βf inclined from the lower left to the upper right when the first machining tool 42F with the tool end face 42A facing down in FIG. 13A is viewed from a direction perpendicular to the tool axis L. Further, as illustrated in FIG. 13B, the second machining tool 42G is designed such that a tooth trace 42bg of the cutting tooth 42ag has the helix angle βg inclined from the lower right to the upper left when the second machining tool 42G with the tool end face 42A facing down in FIG. 13B is viewed from a direction perpendicular to the tool axis L. The first machining tool 42F and the second machining tool 42G described above are designed by the tool designing unit 102 of the control device 100, and the details of the process will be described below.

The following discusses the machining accuracy achieved when the designed first machining tool 42F is applied to the gear machining apparatus 1, and the left tapered flank 121 is cut with different tool conditions of the first machining tool 42F such as the position of the first machining tool 42F in the direction of the tool axis L (hereinafter referred to as an “axial position of the first machining tool 42F”) and the intersection angle φf of the first machining tool 42F. The same applies to the machining accuracy achieved when cutting the right tapered flank 122 with the second machining tool 42G, and therefore a detailed description thereof will not be given.

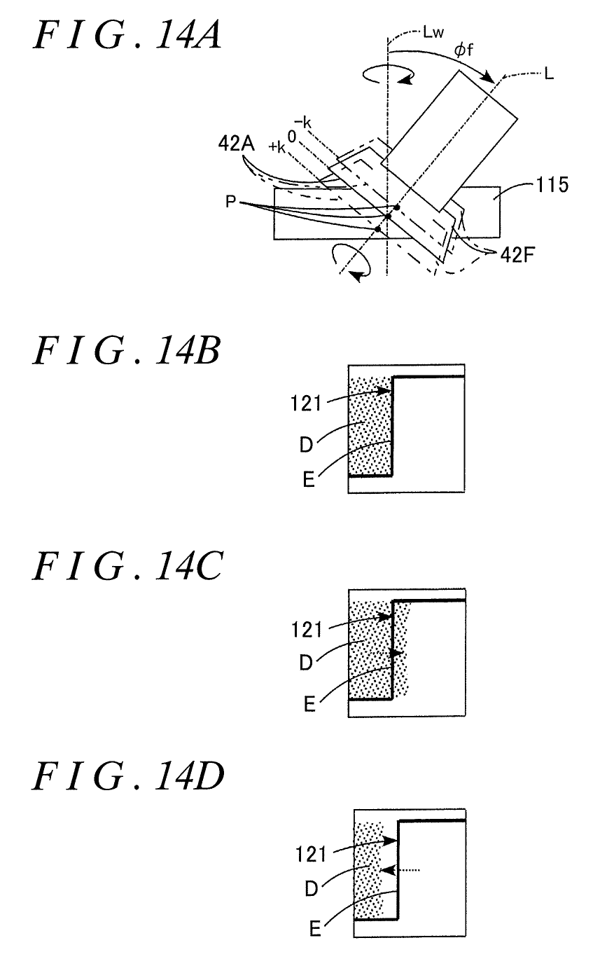

For example, as illustrated in FIG. 14A, the left tapered flank 121 is machined when the axial position of the first machining tool 42F, that is, an intersection P between the tool end face 42A of the first machining tool 42F and the tool axis L is located on the rotation axis Lw of the sleeve 115 (offset amount: 0); when the intersection P is offset by a distance +k in the direction of the tool axis L of the first machining tool 42F (amount of offset: +k); and when the intersection P is offset by a distance −k in the direction of the tool axis L of the first machining tool 42F (the amount of offset: −k). The intersection angle φf of the first machining tool 42F is the same in all the cases.

The resulting machined states of the left tapered flank 121 are illustrated in FIGS. 14B, 14C, and 14D. In FIGS. 14B, 14C, and 14D, the wide continuous line E is a straight line converted from the designed involute curve of the left tapered flank 121, and a dot portion D indicates a cut and removed portion.

As illustrated in FIG. 14B, when the offset amount is 0, the left tapered flank 121 is machined to have a shape close to the designed involute curve. As illustrated in FIG. 14C, when the offset amount is +k, the left tapered flank 121 is machined to have a shape shifted to the right (in the direction of the dashed arrow) in FIG. 14C, that is, shifted clockwise in the pitch circle direction with respect to the designed involute curve. As illustrated in FIG. 14D, when the offset amount is −k, the left tapered flank 121 is machined to have a shape shifted to the left (in the direction of the dotted arrow) in FIG. 14D, that is, shifted counterclockwise in the pitch circle direction with respect to the designed involute curve. Accordingly, by changing the position of the machining tool 42 in the direction of the tool axis L, the shape of the left tapered flank 121 can be shifted in the pitch circle direction.

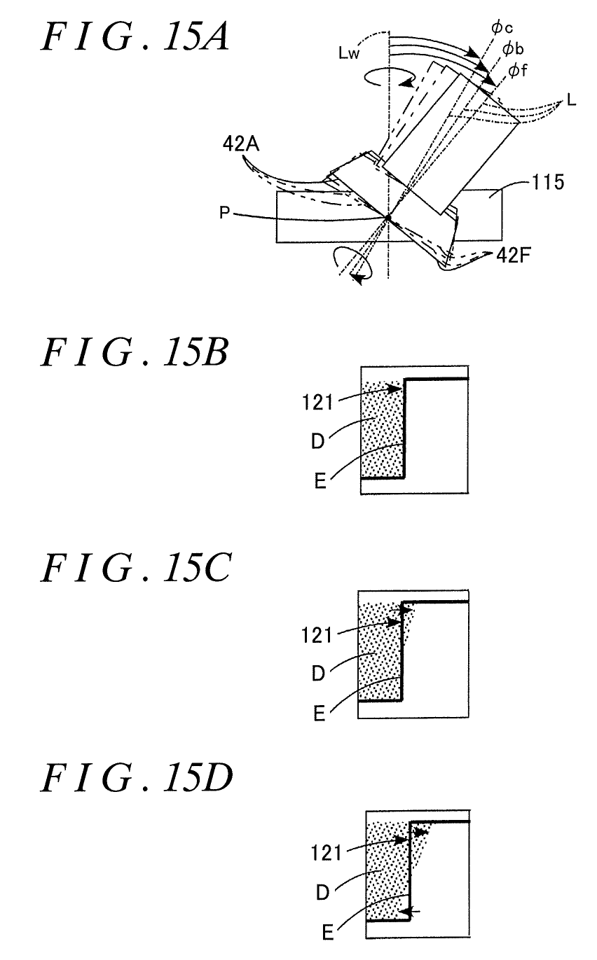

Further, for example, as illustrated in FIG. 15A, the left tapered flank 121 is machined when the intersection angle of the first machining tool 42F is φf; when the intersection angle is φb; and when the intersection angle is φc. The magnitude relationship between the angles is φf>φb>φc. The resulting machined states of the left tapered flank 121 are illustrated in FIGS. 15B, 15C, and 15D.

As illustrated in FIG. 15B, when the intersection angle is φf, the left tapered flank 121 is machined to have a shape close to the designed involute curve. As illustrated in FIG. 15C, when the intersection angle is φb, the left tapered flank 121 is machined to have a shape such that the thickness of the tooth tip is reduced in the pitch circle direction (the solid arrow direction), and the thickness of the tooth root is increased in the pitch circle direction (the solid arrow direction), with respect to the designed involute curve. As illustrated in FIG. 15D, when the intersection angle is φc, the left tapered flank 121 is machined to have a shape such that the thickness of the tooth tip is further reduced in the pitch circle direction (in solid arrow direction), and the thickness of the tooth root is further increased in the pitch circle direction, with respect to the designed involute curve. Accordingly, by changing the intersection angle of the first machining tool 42F, the shape of the left tapered flank 121 can be changed in the thickness of the tooth tip in the pitch circle direction and in the thickness of the tooth root in the pitch circle direction.

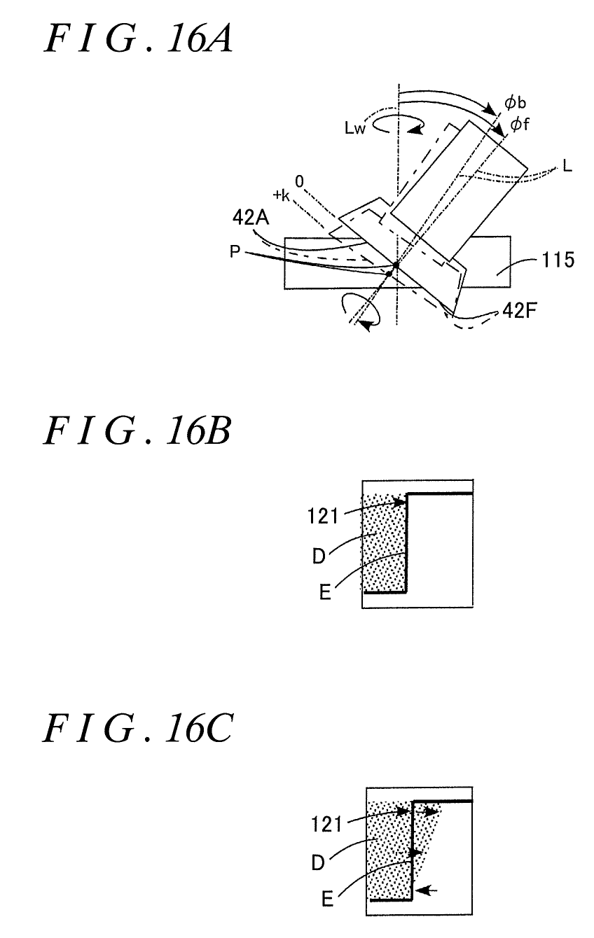

Further, for example, as illustrated in FIG. 16A, the left tapered flank 121 is machined when the axial position of the first machining tool 42F, that is, the intersection P between the tool end face 42A and the tool axis L of the first machining tool 42F is located on the rotation axis Lw of the sleeve 115 (offset amount: 0) and the intersection angle of the first machining tool 42F is φf, and when the intersection P is offset by the distance +k in the direction of the tool axis L of the first machining tool 42F (amount of offset: +k) and the intersection angle is φb. The resulting machined states of the left tapered flank 121 are illustrated in FIGS. 16B and 16C.

As illustrated in FIG. 16B, when the offset amount is 0 and the intersection angle is φf, the left tapered flank 121 is machined to have a shape close to the designed involute curve. Meanwhile, as illustrated in FIG. 16C, when the offset amount is +k and the intersection angle is φb, the left tapered flank 121 is machined to have a shape shifted to the right (in the direction of the dotted arrow) in FIG. 16C, that is, shifted clockwise in the pitch circle direction with respect to the designed involute curve, and such that the thickness of the tooth tip is reduced in the pitch circle direction (the solid arrow direction), and the thickness of the tooth root is increased in the pitch circle direction (the solid arrow direction), with respect to the designed involute curve. Accordingly, by changing axial position of the machining tool 42 and the intersection angle of the first machining tool 42F, the shape of the left tapered flank 121 can be shifted in the pitch circle direction, and can be changed in the thickness of the tooth tip in the pitch circle direction and in the thickness of the tooth root in the pitch circle direction.

In the manner described above, by setting the offset amount to 0 and the intersection angle to φf in the gear machining apparatus 1, the first machining tool 42F can accurately cut the left tapered flank 121. The setting of the tool conditions of the first machining tool 42F and the second machining tool 42G is made by the tool condition calculating unit 103 of the control device 100, and the details of the process will be described below.

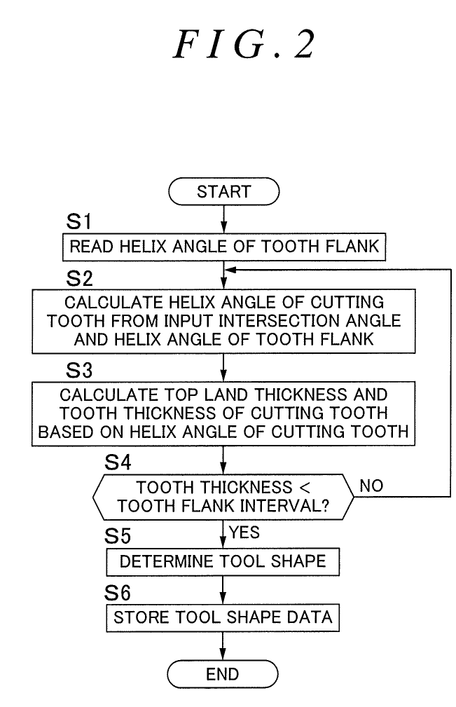

In the following, the process of designing the first machining tool 42F performed by the tool designing unit 102 of the control device 100 will be described with reference to FIGS. 2, 6A, and 6B. It is assumed that data related to the gear disengagement preventing portion 120, that is, the helix angle θf and the tooth trace length ff of the left tapered flank 121, and the tooth trace length gf and the tooth flank interval Hf of the left sub flank 121a, are stored in advance in the storage unit 104. It is also assumed that data related to the first machining tool 42F, that is, the number of teeth Z, the tip diameter da, the reference diameter d, the addendum ha, the module m, the profile shift coefficient λ, the pressure angle α, the transverse pressure angle αt, and the tip pressure angle αa, are stored in advance in the storage unit 104.

The tool designing unit 102 of the control device 100 reads the negative helix angle θf of the left tapered flank 121 from the storage unit 104 (step S1 in FIG. 2). The tool designing unit 102 then calculates the sum of the read negative helix angle θf of the left tapered flank 121 and the positive intersection angle φf of the first machining tool 42F input by the operator, as the helix angle βf (negative in this example) of the tooth trace 42bf of the cutting tooth 42af of the first machining tool 42F (step S2 in FIG. 2).

The tool designing unit 102 reads the number of teeth Z and so on of the first machining tool 42F from the storage unit 104, and calculates the top land thickness Saf and the tooth thickness Taf of the cutting tooth 42af, based on the read number of teeth Z and so on of the first machining tool 42F and the calculated helix angle βf of the tooth trace 42bf of the cutting tooth 42af. The top land thickness Saf of the cutting tooth 42af is calculated from the involute curve based on the tooth thickness Taf. The top land thickness Saf may be calculated as a non-involute or linear tooth flank if a desirable meshing at the teeth portion can be maintained (step S3 in FIG. 2).

The tool designing unit 102 reads the tooth flank interval Hf from the storage unit 104, and determines whether the calculated tooth thickness Taf of the cutting tooth 42af is less than the tooth flank interval Hf (step S4 in FIG. 2). When the calculated tooth thickness Taf of the cutting tooth 42af is greater than or equal to the tooth flank interval Hf, the process returns to step S2 and repeats the above steps.

When the calculated tooth thickness Taf of the cutting tooth 42af is less than the tooth flank interval Hf, the tool designing unit 102 determines the shape of the machining tool 42 based on the calculated helix angle βf of the tooth trace 42bf of the cutting tooth 42af and so on (step S5 in FIG. 2), and stores the determined shape data of the first machining tool 42F in the storage unit 104 (step S6 in FIG. 2). Thus, the entire process ends. In this manner, the first machining tool 42F having the optimal cutting teeth 42af is designed.

By performing the above process also for the second machining tool 42G;

the second machining tool 42G having the optimal cutting teeth 42ag is designed. The first machining tool 42F has a positive helix angle βf as illustrated in FIG. 13A, and the second machining tool 42G has a negative helix angle βg as illustrated in FIG. 13B.

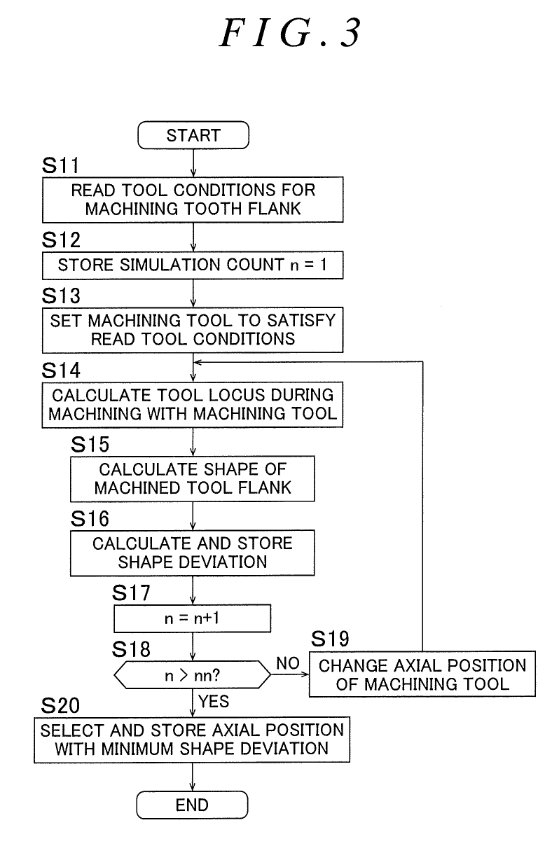

In the following, the process performed by the tool condition calculating unit 103 of the control device 100 will be described with reference to FIG. 3. As this process is a simulation process for calculating the locus of the cutting tooth 42af of the first machining tool 42F based on a known gear generation theory, actual machining is not needed, and therefore the cost can be reduced.

The tool condition calculating unit 103 of the control device 100 reads the tool conditions for cutting of the left tapered flank 121, such as the axial position of the first machining tool 42F, from the storage unit 104 (step S11 in FIG. 3), stores 1 as the simulation count n in the storage unit 104 (step S12 in FIG. 3), and sets the first machining tool 42F to satisfy the read tool conditions (step S13 in FIG. 3).

The tool condition calculating unit 103 calculates the tool locus during machining of the left tapered flank 121 based on the shape data of the first machining tool 42F read from the storage unit 104 (step S14 in FIG. 3), and calculates the shape of the machined left tapered flank 121 (step S15 in FIG. 3). The tool condition calculating unit 103 then compares the calculated shape of the machined left tapered flank 121 and the shape of the designed left tapered flank 121, calculates a shape deviation and stores the calculated shape deviation in the storage unit 104 (step S16 in FIG. 3), and increments the simulation count n by 1 (step S17 in FIG. 3).

The tool condition calculating unit 103 determines whether the simulation count n has reached a predetermined count nn (step S18 in FIG. 3). When the simulation count n has not reached the predetermined count nn, the tool condition calculating unit 103 changes, for example, the axial position of the first machining tool 42F among the tool conditions of the first machining tool 42F (step S19 in FIG. 3). Then, the process returns to step S14 and repeats the above steps. On the other hand, when the simulation count n has reached the predetermined count nn, the tool condition calculating unit 103 selects the axial position of the first machining tool 42F which has the minimum deviation out of the stored shape deviations, and stores the selected axial position in the storage unit 104 (step S20 in FIG. 3). Thus, the whole process ends.

In the process described above, the simulation is performed multiple times, and the axial position of the first machining tool 42F that has the minimum deviation is selected. However, an allowable shape deviation may be set in advance, and the axial position of the first machining tool 42F at which the shape deviation calculated in step S16 is less than or equal to the allowable shape deviation may be selected. Further, in step S19, instead of changing the axial position of the first machining tool 42F, the intersection angle φf of the first machining tool 42F may be changed. Alternatively, the position of the first machining tool 42F in the direction about the axis may be changed, or any combination of the intersection angle, the axial position, and the position in the direction about the axis may be changed.

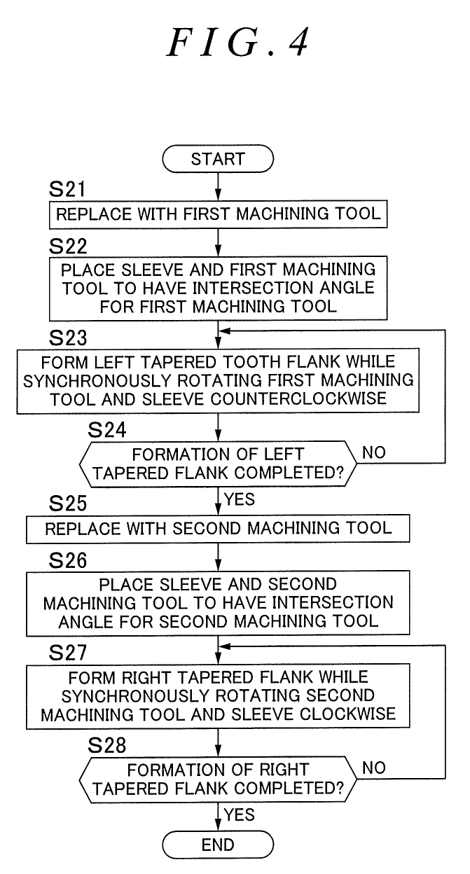

In the following, the process (gear machining method) performed by the machining control unit 101 of the control device 100 will be described with reference to FIG. 4. It is assumed here that the operator has produced the first machining tool 42F and the second machining tool 42G based on the shape data of the first machining tool 42F and the shape data of the second machining tool 42G designed by the tool designing unit 102, and has installed the first machining tool 42F and the second machining tool 42G in the automatic tool replacement device in the gear machining apparatus 1. It is also assumed that the sleeve 115 is mounted on the workpiece holder 80 of the gear machining apparatus 1, and the inner teeth 115a are formed by broaching, gear shaping, or the like.

The machining control unit 101 of the control device 100 causes the automatic tool replacement device to replace the machining tool used in the previous machining step (broaching, gear shaping, or the like) with the first machining tool 42F (step S21 in FIG. 4). The machining control unit 101 places the first machining tool 42F and the sleeve 115 such that the tool conditions of the first machining tool 42F calculated by the tool condition calculating unit 103 are satisfied, that is, such that the intersection angle between the rotation axis Lw of the sleeve 115 and the rotation axis L of the first machining tool 42F (corresponding to a “first intersection angle” according to the present invention) is set to φf (step S22 in FIG. 4, corresponding to a “first intersection angle setting step” according to the present invention).

Next, the machining control unit 101 cuts the inner tooth 115a by feeding (moving) the first machining tool 42F in the direction of the rotation axis Lw of the sleeve 115 while synchronously rotating the first machining tool 42F and the sleeve 115 counterclockwise, and forms the left tapered flank 121 including the left sub flank 121a on the inner tooth 115a (step S23 in FIG. 4, corresponding to a “first rotational direction setting step” according to the present invention).

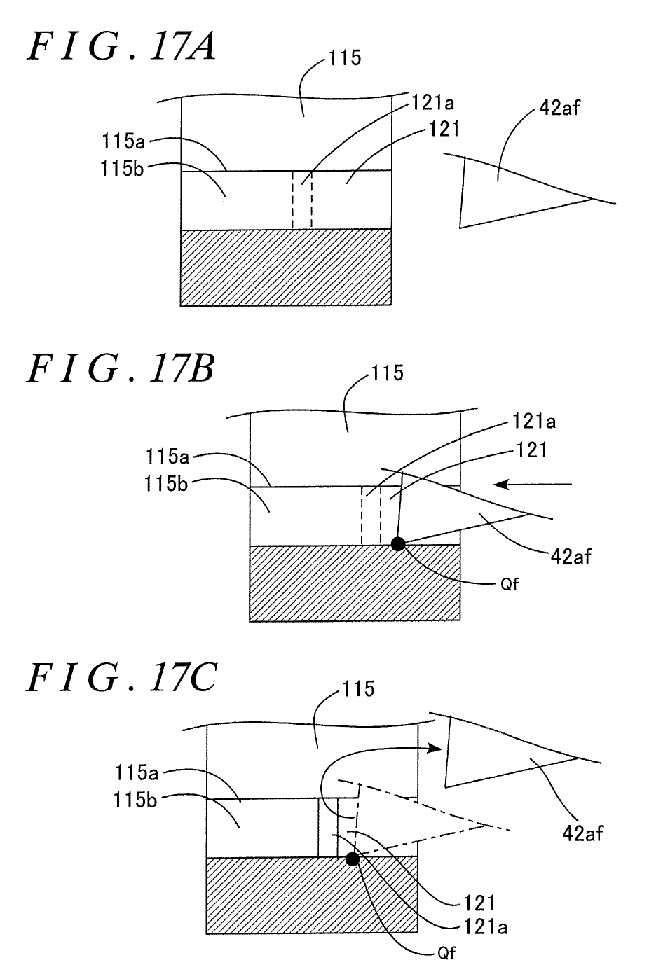

That is, as illustrated in FIGS. 17A to 17C, the first machining tool 42F forms the left tapered flank 121 including the left sub flank 121a on the inner tooth 115a by one or more cutting actions in the direction of the rotation axis Lw of the sleeve 115. In this step, the first machining tool 42F needs to perform a feeding operation, and a retracting operation in the direction opposite to the direction of the feeding operation. As illustrated in FIG. 17C, this reversing operation is associated with an inertial force. Therefore, the feeding operation of the first machining tool 42F ends at a cutting end position Qf, the distance to which is less by a predetermined length than the tooth trace length ff of the left tapered flank 121 with which the left tapered flank 121 including the left sub flank 121a can be formed, and is switched to the retracting operation.

The cutting end position Qf may be calculated by measuring with a sensor or the like. However, if the feeding amount accuracy is high enough to achieve the required machining accuracy, the feeding amount may be adjusted without calculating the cutting end position Qf. That is, accurate machining is achieved by performing cutting while adjusting the feeding amount so as to machine up to the cutting end position Qf.

When cutting of the left tapered flank 121 is completed (step S24 in FIG. 4), the machining control unit 101 causes the automatic tool replacement device to replace the first machining tool 42F with the second machining tool 42G (step S25 in FIG. 4). The machining control unit 101 then places the second machining tool 42G and the sleeve 115 such that the tool conditions of the second machining tool 42G calculated by the tool condition calculating unit 103 are satisfied, that is, such that the intersection angle between the rotation axis Lw of the sleeve 115 and the rotation axis L of the second machining tool 42G (corresponding to a “second intersection angle” according to the present invention) is set to φg (φf and φg have the same absolute value) (step S26 in FIG. 4, corresponding to a “second intersection angle setting step” according to the present invention).

The machining control unit 101 cuts the inner tooth 115a by feeding (moving) the second machining tool 42G in the direction of the rotation axis Lw of the sleeve 115 while synchronously rotating the second machining tool 42G and the sleeve 115 clockwise, and forms the right tapered flank 122 including the right sub flank 122a on the inner tooth 115a (step S27 in FIG. 4, corresponding to a “second rotational direction setting step” according to the present invention). When cutting of the right tapered flank 122 is completed (step S28 in FIG. 4), the whole process ends.

In the example described above, the left tapered flank 121 and the right tapered flank 122 of the gear disengagement preventing portion 120 of the sleeve 115 are cut using two machining tools 42 (the first machining tool 42F and the second machining tool 42G). The following describes an example where the left tapered flank 121 and the right tapered flank 122 are cut using one machining tool 42.

For cutting the left tapered flank 121 and the right tapered flank 122 having different helix angles using one machining tool 42, a machining tool 42 that has cutting teeth 42a each including a right flank and a left flank having different helix angles may be used, or a machining tool 42 that has cutting teeth 42a each including a right flank and a left flank having the same helix angle may be used. In this example, a machining tool 42 that has cutting teeth 42a each including a right flank and a left flank having the same helix angle is used for cutting. The parameters of the machining tool 42 can be obtained by removing the suffixes “f” and “g” from the parameters of the first machining tool 42F and the second machining tool 42G.

As in the case of the first machining tool 42F and the second machining tool 42G; the cutting tooth 42a of the machining tool 42 needs to have a shape that, while cutting the inner tooth 115a, reliably allows cutting the left tapered flank 121 including the left sub flank 121a and the right tapered flank 122 including the right sub flank 122a, without interference with the adjacent inner tooth 115a. Accordingly, the machining tool 42 is designed by the tool designing unit 102 of the control device 100.

In the case of the machining tool 42, the side relief angle ε of the cutting tooth 42a needs to be greater than the intersection angle φ such that, while cutting the inner tooth 115a, the machining tool 42 does not interfere with the adjacent inner tooth 115a In this regard, the first and second machining tools 42F and 42G can have greater tooth thicknesses Taf and Tag and thus can secure durability.

The machining tool 42 needs to accurately cut the left tapered flank 121 including the left sub flank 121a, and the right tapered flank 122 including the right sub flank 122a. Accordingly, the conditions of the machining tool 42 are set by the tool condition calculating unit 103 of the control device 100. The cutting with the machining tool 42 is performed by the machining control unit 101. The process performed by the tool condition calculating unit 103 is the same as that in the above example, and the process performed by the machining control unit 101 is the same as that in the above example except that replacement of tools is not performed. Therefore these processes will not be described in detail. The following describes the process performed by the tool designing unit 102.

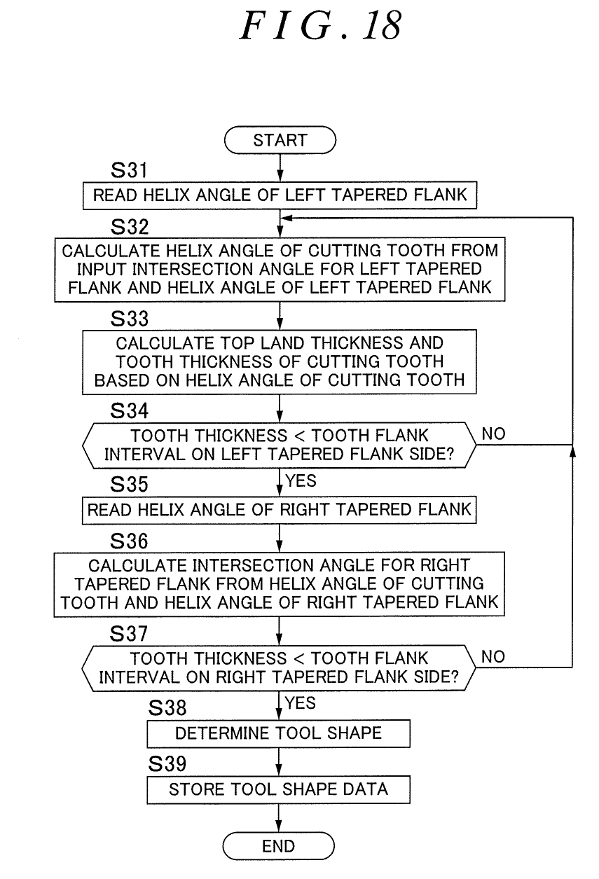

The process of designing the machining tool 42 performed by the tool designing unit 102 of the control device 100 will be described with reference to FIG. 18. It is assumed that data related to the gear disengagement preventing portion 120, that is, the helix angle θf and the tooth trace length ff of the left tapered flank 121, the tooth trace length gf and the tooth flank interval Hf of the left sub flank 121a, the helix angle θg and a tooth trace length fg of the right tapered flank 122, and a tooth trace length gg and a tooth flank interval Hg of the right sub flank 122a, are stored in advance in the storage unit 104. It is also assumed that data related to the machining tool 42, that is, the number of teeth Z, the tip diameter da, the reference diameter d, the addendum ha, the module m, the profile shift coefficient λ, the pressure angle α, the transverse pressure angle αt, and the tip pressure angle αa, are stored in advance in the storage unit 104.

The tool designing unit 102 of the control device 100 reads the negative helix angle θf of the left tapered flank 121 from the storage unit 104 (step S31 in FIG. 18). The tool designing unit 102 calculates the sum of the positive intersection angle ϕ of the machining tool 42 during cutting of the left tapered flank 121, which is input by the operator, and the read negative helix angle θf of the left tapered flank 121, as the helix angle β (zero in this example) of a tooth trace 42b of the cutting tooth 42a of the machining tool 42 (step S32 in FIG. 18).

The tool designing unit 102 reads the number of teeth Z and so on of the machining tool 42 from the storage unit 104, and calculates a top land thickness Sa and a tooth thickness Ta of the cutting tooth 42a, based on the read number of teeth Z and so on of the machining tool 42 and the calculated helix angle β of the tooth trace 42b of the cutting tooth 42a. The top land thickness Sa of the cutting tooth 42a is calculated from the involute curve based on the tooth thickness Ta. The top land thickness Sa may be calculated as a non-involute or linear tooth flank if a desirable meshing can be maintained at the teeth portion (step S33 in FIG. 18).

The tool designing unit 102 reads the tooth flank interval Hf from the storage unit 104, and determines whether the calculated tooth thickness Ta of the cutting tooth 42a is less than the tooth flank interval Hf on the left tapered flank 121 side (step S34 in FIG. 18). When the calculated tooth thickness Ta of the cutting tooth 42a is greater than or equal to the tooth flank interval Hf on the left tapered flank 121 side, the process returns to step S32 and repeats the above steps.

When the calculated tooth thickness Ta of the cutting tooth 42a is less than the tooth flank interval Hf on the left tapered flank 121 side, the tool designing unit 102 reads the positive helix angle θg of the right tapered flank 122 from the storage unit 104 (step S35 in FIG. 18). The tool designing unit 102 then calculates the difference between the helix angle β (zero in this example) of the tooth trace 42b of the cutting tooth 42a of the machining tool 42 obtained in step S32 and the read positive helix angle θg of the right tapered flank 122, as the intersection angle φ of the machining tool 42 during cutting of the right tapered flank 122 (step S36 in FIG. 18).

The tool designing unit 102 reads the tooth flank interval Hg from the storage unit 104, and determines whether the tooth thickness Ta is less than the tooth flank interval Hg on the right tapered flank 122 side (step S37 in FIG. 13). When the tooth thickness Ta is greater than or equal to the tooth flank interval Hg on the right tapered flank 122 side, the process returns to step S32 and repeats the above steps.

When the tooth thickness Ta is less than the tooth flank interval Hg on the right tapered flank 122 side, the tool designing unit 102 determines the shape of the machining tool 42 based on the calculated helix angle β (zero in this example) of the tooth trace 42b of the cutting tooth 42a and so on (step S38 in FIG. 13), and stores the determined shape data of the machining tool 42 in the storage unit 104 (step S39 in FIG. 13). Thus, the entire process ends.

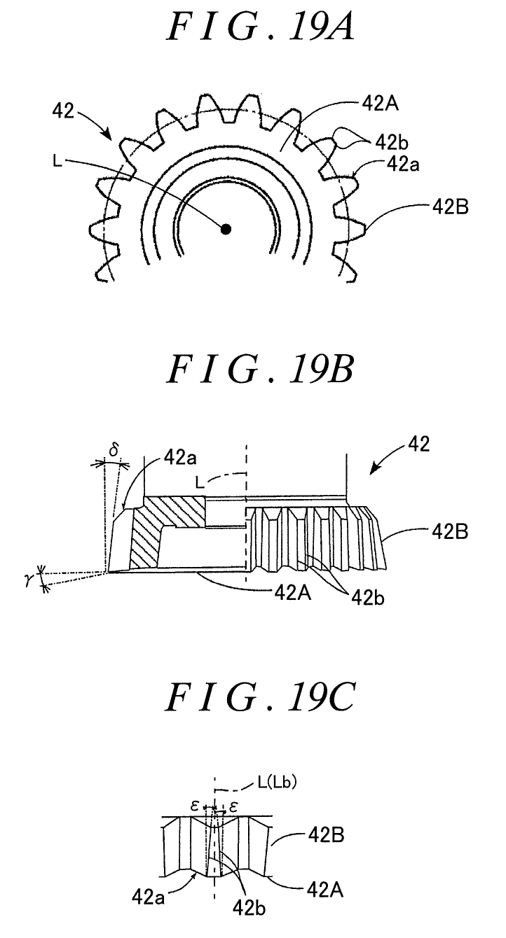

In the manner described above, the machining tool 42 having the optimal cutting teeth 42a is designed as illustrated in FIGS. 19A to 19C for comparison with FIGS. 5A to 5C. The machining tool 42 is different from the first machining tool 42F in that a line Lb at the center between the two tooth traces 42b of the cutting tooth 42a is parallel to the tool axis L, that is, the helix angle βf is zero, when the line Lb is viewed in the radial direction.

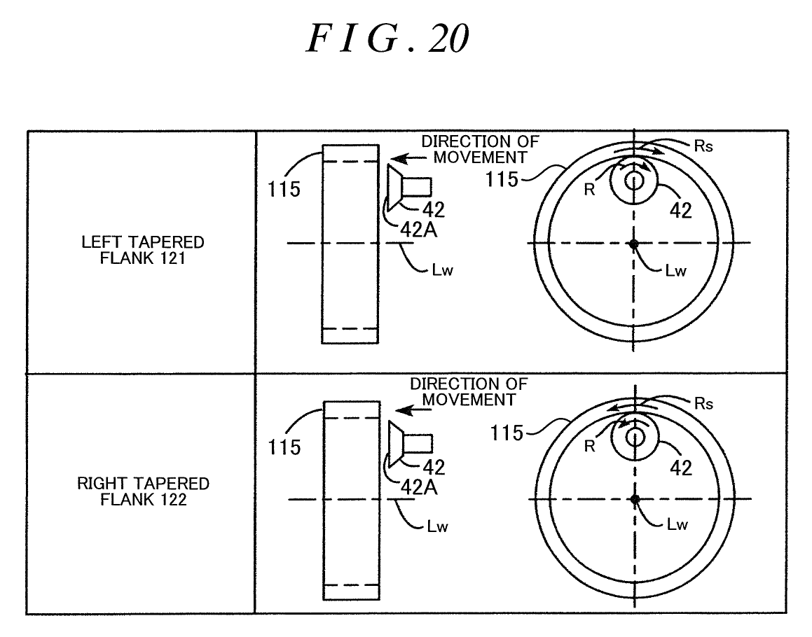

When the left tapered flank 121 and the right tapered flank 122 are machined with the machining tool 42, the intersection angle φf during machining of the left tapered flank 121 and the intersection angle φg during machining of the right tapered flank 122 are set to values with opposite signs having the same absolute value, that is, φg=−φf. Further, for example, as illustrated in FIG. 20, the machining position of the machining tool 42 during machining of the left tapered flank 121 and the machining position of the machining tool 42 during machining of the right tapered flank 122 are set to the same position (an upper position of the sleeve 115 in FIG. 20).

In FIG. 20, a rotational direction R of the machining tool 42 during machining of the left tapered flank 121 and the rotational direction Rs of the sleeve 115 are set to the same clockwise direction, and the rotational direction R of the machining tool 42 during machining of the right tapered flank 122 and the rotational direction Rs of the sleeve 115 are set to the same counterclockwise direction. Thus, the machining tool 42 can perform machining in the same manner as the first and second machining tools 42F and 42G (see FIGS. 10A and 10B).

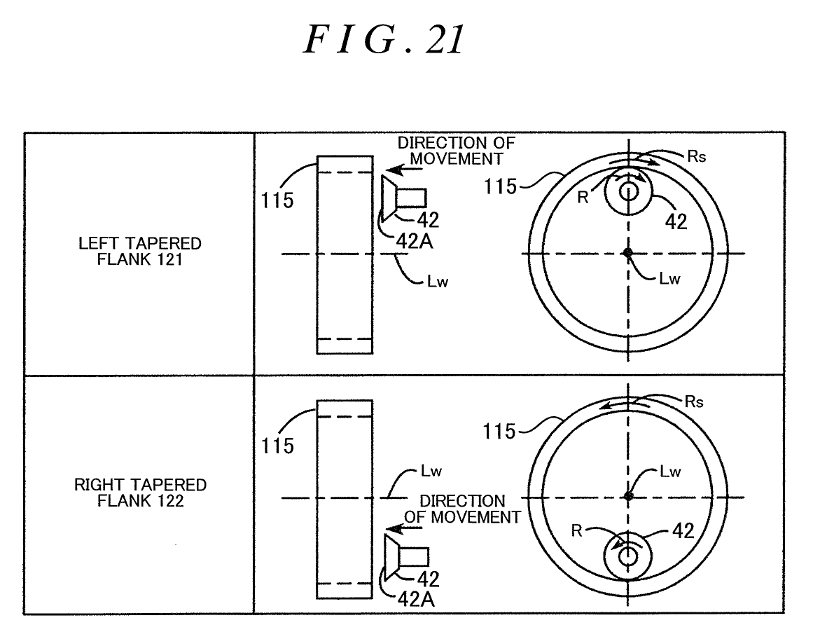

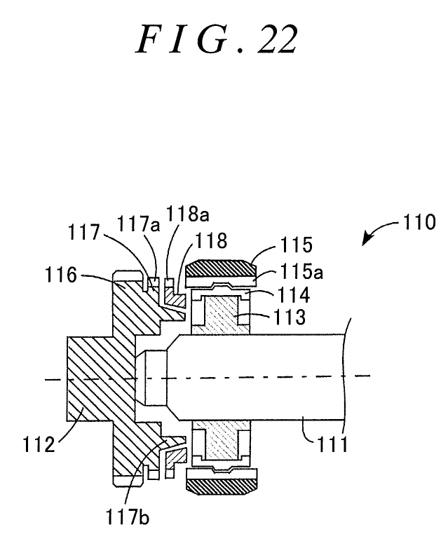

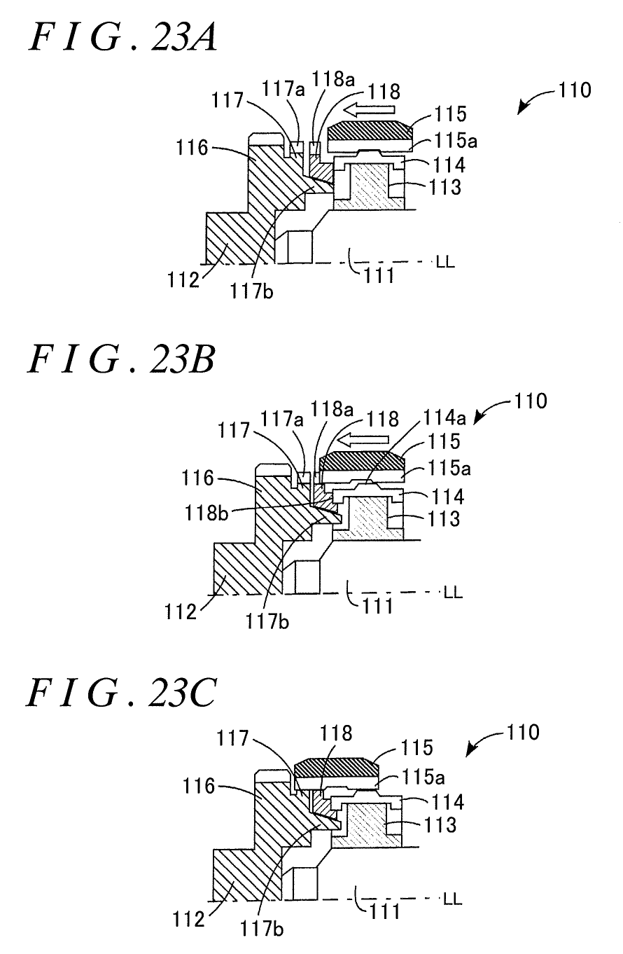

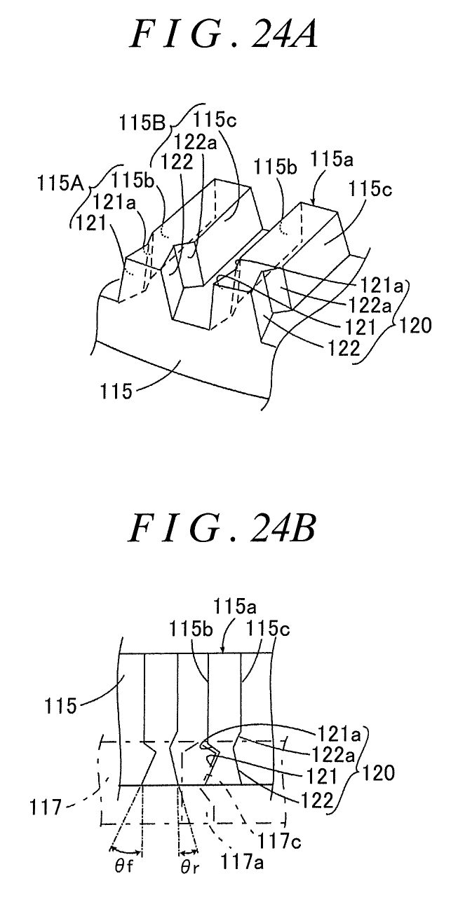

Alternatively, when the left tapered flank 121 and the right tapered flank 122 are machined with the machining tool 42, the intersection angle φf during machining of the left tapered flank 121 and the intersection angle φg during machining of the right tapered flank 122 may be set to the same value, that is, φg=φf. In this case, as illustrated in FIG. 21 for comparison with FIG. 20, the machining position of the machining tool 42 during machining of the left tapered flank 121 is set to the same position as the machining position in FIG. 20 (an upper position of the sleeve 115), but the machining position of the machining tool 42 during machining of the right tapered flank 122 is set to a position (a lower position of the sleeve 115) that is 180 degrees apart from the machining position in FIG. 20 about the rotation axis Lw of the sleeve 115.

In this case as well, the rotational direction R of the machining tool 42 during machining of the left tapered flank 121 and the rotational direction Rs of the sleeve 115 are set to the same clockwise direction in the same manner as the rotational directions in FIG. 20, and the rotational direction R of the machining tool 42 during machining of the right tapered flank 122 and the rotational direction Rs of the sleeve 115 are set to the same counterclockwise direction in the same manner as the rotational directions in FIG. 20.

In the gear machining apparatus 1, the intersection angle between the machining tool 42 and the sleeve 115 is set to φf, and the machining position of the machining tool 42 is set to the upper position of the sleeve 115. The machining tool 42 and the sleeve 115 are synchronously rotated in the same clockwise direction to machine the left tapered flank 121. Subsequently, while the intersection angle between the machining tool 42 and the sleeve 115 is maintained at φf, the machining position of the machining tool 42 is set to the lower position of the sleeve 115 that is 180 degrees apart about the rotation axis Lw of the sleeve 115 by relatively moving the machining tool 42 and the sleeve 115. The machining tool 42 and the sleeve 115 are synchronously rotated in the same counterclockwise direction to machine the right tapered flank 122. Thus, the machining tool 42 can perform machining in the same manner as the first and second machining tools 42F and 42G (see FIGS. 10A and 10B).

In the above example, the rotational direction Rf of the first machining tool 42F is counterclockwise, and the rotational direction Rs of the sleeve 115 is also counterclockwise. Further, the rotational direction Rg of the second machining tool 42G is clockwise, and the rotational direction Rs of the sleeve 115 is also clockwise. However, the rotational direction Rf of the first machining tool 42F may be clockwise, and the rotational direction Rs of the sleeve 115 may also be clockwise. Further, the rotational direction Rg of the second machining tool 42G may be counterclockwise, and the rotational direction Rs of the sleeve 115 may also be counterclockwise. In this case, although the release length ef of the left sub flank 121a is increased to be the same as the release length eg of the right sub flank 122a, the shape of the left sub flank 121a and the shape of the right sub flank 122a can be made symmetrical to each other.

In the above description, the inner teeth 115a of the sleeve 115 are formed by broaching, gear shaping, or the like. However, all the inner teeth 115a of the sleeve 115 and the gear disengagement preventing portions 120 may be formed by cutting with the machining tool 42F, 42G or 42. Further, inner teeth are machined in the above description. However, outer teeth may be machined in the same manner.

[01H] In the above description, the workpiece is the sleeve 115 of the synchromesh mechanism 110. However, the workpiece may be any workpiece that has teeth to mesh such as gears, or that has a cylindrical shape or a disk shape, and a plurality of tooth flanks (a plurality of different tooth traces (tooth profiles (tooth tip and tooth root)) may be machined on one or both of inner periphery (inner teeth) and an outer periphery (outer teeth) in the same manner. A continuously-changing tooth trace and tooth profile (tooth tip and tooth root) such as crowning and relieving may also be machined in the same manner, and optimal (desirable) meshing can be achieved.

In particular, with a method (gear skiving) that machines the sleeve 115 (workpiece) with the machining tool 42F, 42G or 42 whose rotation axis L is not perpendicular to the rotation axis Lw of the sleeve 115, while the machining tool 42F, 42G, or 42 and the sleeve 115 are synchronously rotated at high speed, it is possible to perform machining efficiently. In the case of machining the sleeve 115 (workpiece) having right and left tooth traces that extend in different directions and are discontinuous, the machining (cutting) conditions during the period from when the cutting tooth 42af, 42ag, or 42a of the machining tool 42F, 42G or 42 comes into contact with the sleeve 115 (workpiece) to when the cutting tooth 42af, 42ag, or 42a separates from the sleeve 115 differ (the removal state (chip thickness), the rake angle, the cutting force, and so on with respect to the tool rotation angle differ) between when machining the right flank and when machining the left flank. Accordingly, the right and left flanks of each tooth of the machined sleeve 115 (workpiece) may have shapes that are not symmetrical to each other. However, with the gear machining apparatus 1 (gear machining method) described above, it is possible to form the right and left flanks of the tooth of the sleeve 115 (workpiece) to have shapes symmetrical to each other.

In the examples described above, the gear machining apparatus 1, which is a five-axis machining center, is configured such that the sleeve 115 is rotatable about the A axis. The five-axis machining center may be a vertical machining center configured such that the machining tools 42F, 42G and 42 are rotatable about the A axis. Further, in the above description, the present invention is applied to a machining center. The present invention may also be applied to apparatuses dedicated to gear machining.

What is claimed is:

1. A gear machining apparatus comprising:
a control device that controls machining of a gear by relatively moving a machining tool in a rotation axis direction of a workpiece while rotating the machining tool in synchronization with the workpiece, the machining tool including a plurality of cutting teeth on an outer periphery of the machining tool, wherein:
one side surface of each of teeth of the gear includes a first tooth flank, and a second tooth flank having a different helix angle from the first tooth flank;
another side surface of each of the teeth of the gear includes a third tooth flank, and a fourth tooth flank having a different helix angle from the third tooth flank; and
the control device is configured to
set a first intersection angle between a rotation axis of the workpiece and a rotation axis of the machining tool during machining of the second tooth flank,
set a rotational direction of the workpiece and a rotational direction of the machining tool during machining of the second tooth flank to a same rotational direction, and
set a rotational direction of the workpiece and a rotational direction of the machining tool during machining of the fourth tooth flank to a same rotational direction that is opposite to the rotational direction during machining of the second tooth flank.

2. The gear machining apparatus according to claim 1, wherein the control device performs control to set a second intersection angle between the rotation axis of the workpiece and the rotation axis of the machining tool during machining of the fourth tooth flank such that the second intersection angle has a same value as the first intersection angle and is in a direction opposite to a direction of the first intersection angle.

3. The gear machining apparatus according to claim 1, wherein the control device performs control to machine the second tooth flank or the fourth tooth flank that faces a side surface of each of the cutting teeth facing the rotational direction of the workpiece, using the machining tool.

4. The gear machining apparatus according to claim 1, wherein the control device performs control to machine the second tooth flank or the fourth tooth flank that faces a side surface of each of the cutting teeth facing a direction opposite to the rotational direction of the workpiece, using the machining tool.

5. The gear machining apparatus according to claim 1, wherein:
the machining tool includes a first machining tool and a second machining tool;
the first machining tool has a helix angle that is set based on the helix angle of the second tooth flank and an intersection angle between the rotation axis of the workpiece and a rotation axis of the first machining tool so that the first machining tool machines the second tooth flank on the first tooth flank that is machined previously; and
the second machining tool has a helix angle that is set based on the helix angle of the fourth tooth flank and an intersection angle between the rotation axis of the workpiece and a rotation axis of the second machining tool, and that has a same value as the helix angle of the first machining tool and is in a direction opposite to a direction of the helix angle of the first machining tool so that the second machining tool machines the fourth tooth flank on the third tooth flank that is machined previously.

6. The machining apparatus according to claim 1, wherein a helix angle of the cutting teeth of the machining tool is zero.

7. The gear machining apparatus according to claim 1, wherein:
the gear is a sleeve of a synchromesh mechanism; and
the second tooth flank and the fourth tooth flank are tooth flanks of a gear disengagement preventing portion provided on each of inner teeth of the sleeve.

8. A gear machining method of machining a gear by relatively moving a machining tool in a rotation axis direction of a workpiece while rotating the machining tool in synchronization with the workpiece, the machining tool including a plurality of cutting teeth on an outer periphery of the machining tool, wherein:
one side surface of each of teeth of the gear includes a first tooth flank, and a second tooth flank having a different helix angle from the first tooth flank; and
another side surface of each of the teeth of the gear includes a third tooth flank, and a fourth tooth flank having a different helix angle from the third tooth flank;
the gear machining method comprising:
a first intersection angle setting step of setting a first intersection angle between a rotation axis of the workpiece and a rotation axis of the machining tool during machining of the second tooth flank;
a first rotational direction setting step of setting a rotational direction of the workpiece and a rotational direction of the machining tool during machining of the second tooth flank to a same rotational direction; and
a second rotational direction setting step of setting a rotational direction of the workpiece and a rotational direction of the machining tool during machining of the fourth tooth flank to a same rotational direction that is opposite to the rotational direction during machining of the second tooth flank.
